(19) United States
(12) Patent Application Publication
(10) Pub. No.: US 2026/0286897 A1
(43) Pub. Date: Sep. 24, 2026

(54) GAS TURBINE ARRANGEMENT WITH AMMONIA CRACKER AND POWER PLANT WITH SUCH AND METHOD TO OPERATE A GAS TURBINE ARRANGEMENT

(71) Applicant: Siemens Energy Global GmbH & Co. KG, Munich, Bayern (DE)

(72) Inventors: Lennart Näs, Norrkoping (SE); Karl-Johan Nogenmyr, Linghem (SE); Olle Lindman, Finspang (SE)

(73) Assignee: Siemens Energy Global GmbH & Co. KG, Munich, Bayern (DE)

(21) Appl. No.: 19/476,697

(22) PCT Filed: Mar. 29, 2024
(86) PCT No.: PCT/EP2024/058744

§ 371 Date: Oct. 19, 2025

(30) Foreign Application Priority Data
Apr. 28, 2023 (GB) 2306311.8

(51) Int. Cl. F02C 7/224; F02C 3/22; F02C 7/22; F23R 3/28

(52) U.S. Cl. CPC F02C 7/224; F02C 3/22; F02C 7/222; F23R 3/28

(57) ABSTRACT

A gas turbine arrangement including a gas turbine and an ammonia cracker. The gas turbine has a compressor, a combustor and a high-pressure expansion turbine and a low-pressure expansion turbine. The ammonia cracker includes a cracker air channel from a cracker air inlet to a cracker air outlet and a cracker reaction channel from a cracker ammonia inlet to a cracker fuel outlet, wherein a fuel piping connects the cracker fuel outlet with the combustor. To increase the efficiency of the gas turbine arrangement the ammonia cracker is arranged in-between the high-pressure expansion turbine and the low-pressure expansion turbine and in operation the exhaust gas passes the cracker air channel.

### CROSS REFERENCE TO RELATED APPLICATIONS

This application is the US National Stage of International Application No. PCT/EP 2024/058744 filed 29 Mar. 2024, and claims the benefit thereof, which is incorporated by reference herein in its entirety. The International Application claims the benefit of United Kingdom Application No. GB 2306311.8 filed 28 Apr. 2023.

### TECHNICAL FIELD

The invention is about a gas turbine arrangement including an ammonia cracker. The gas turbine comprises as usual a compressor, a combustion section, and an expansion turbine. The ammonia cracker is used to crack the ammonia into a mixture of hydrogen and nitrogen, wherein the hydrogen could be combusted in the gas turbine combustion section.

### BACKGROUND

Conventionally, a natural gas is used as fuel in most gas turbines. To reduce the amount of carbon dioxide it is preferred to use hydrogen as fuel for the gas turbine. The supply and storage of hydrogen is expensive and raises safety concerns. Therefore, ammonia is a preferred medium to store and transport hydrogen from a place of production to a power plant.

The direct combustion of ammonia as fuel in a gas turbine is not possible due to the release of an unallowable amount of nitrogen oxides (NOx). Furthermore, the direct combustion of ammonia is difficult due to its ignition inertia. Therefore, it is required to crack at least part of the ammonia into hydrogen and nitrogen before its combustion in the combustion chamber of the gas turbine.

For cracking of the ammonia, a high temperature is required. Here, very different technologies are used to achieve the required heat within an ammonia cracker.

In general, it is preferred to operate the power plant including the cracking of ammonia and the operation of the gas turbine as efficiently as possible, with minimum waste of energy. Next, it is preferred that no external heat sources or energy sources are required for the cracking of ammonia.

Exemplary solutions to enable the combustion of ammonia are presented in EP3314166B1, EP3377745B1 and EP3417205B1. In all cases a share of the ammonia is supplied to an ammonia cracker and the resulting hydrogen and nitrogen are further supplied to the combustor of the gas turbine. Advantageously the heat of the exhaust gas from the gas turbine is used to heat the ammonia cracker. But the known solutions always require a high installation effort.

### SUMMARY OF INVENTION

The task for the current invention is the development of an alternative solution for the ammonia cracker installed at a gas turbine with a high efficiency and less installation effort. Also, the usage of external heat or an external energy source should be avoided—as far as possible.

The task is solved by an inventive gas turbine arrangement according claim 1. An inventive method to operate a gas turbine arrangement with an ammonia cracker is defined in claim 7. Advantageous embodiments are subject of the subclaims.

A gas turbine arrangement comprises a gas turbine having a compressor and at least one combustor and an expansion turbine, wherein the expansion turbine is split into a high-pressure expansion turbine in connection with the compressor and further a low-pressure expansion turbine.

In operation of the gas turbine, combustion air—which is in usual filtered ambient air—is compressed by the compressor and supplied to the at least one combustor. Fuel is combusted in the combustor and hot exhaust gas is guided through the high-pressure expansion turbine and further downstream through the low-pressure expansion turbine.

Further, the gas turbine arrangement requires at least one ammonia cracker, which comprises a cracker air channel and a cracker reaction channel. In use of the gas turbine arrangement the cracker reaction channel is supplied with ammonia, wherein a fuel piping connects the cracker reaction channel outlet with the combustor.

An efficient cracking process is enabled by the arrangement of the ammonia cracker in-between the high-pressure expansion turbine and the low-pressure expansion turbine, wherein in operation of the gas turbine the exhaust gas passes the cracker air channel.

A generic gas turbine arrangement comprises a gas turbine and an ammonia cracker.

The generic gas turbine comprises a compressor and at least one combustor and an expansion turbine, wherein the expansion turbine is split into a high-pressure expansion turbine and further a low-pressure expansion turbine. Regularly the high-pressure expansion turbine is connected with the compressor through a common rotor (the compressor is driven by the high-pressure expansion turbine).

In operation of the gas turbine, combustion air—which is in usual filtered ambient air—is compressed by the compressor and supplied to the at least one combustor.

Different kinds of combustion arrangements could be used for the inventive solution. It is possible to use an annular combustion chamber with a number of burners distributed around the gas turbine centre axis. Alternative, a silo combustion system or a number of can-combustors distributed around the gas turbine centre axis each having usually one burner could be used.

A fuel needs to be supplied to the at least one burner of the at least one combustor in operation of the gas turbine, which is burned in the at least one combustor generating a flow of hot exhaust gas.

The high-pressure expansion turbine is arranged downstream of the at least one combustor, driven in operation of the gas turbine by the flow of hot exhaust gas.

Downstream of the high-pressure expansion turbine the low-pressure expansion turbine is arranged. After expansion of the hot exhaust gas in the low-pressure expansion turbine the exhaust gas leaves the expansion turbine with a reduced temperature at the output end of the gas turbine.

The generic ammonia cracker is required for the cracking of the ammonia into hydrogen and nitrogen. Therefore, the ammonia cracker has a cracker reaction channel starting at a cracker ammonia inlet and ending at a cracker fuel outlet. For operation of the gas turbine arrangement, it is required to connect the cracker ammonia inlet with a source of ammonia. A fuel piping is connecting the cracker fuel outlet with the at least one combustor. If several burners are given, it is obvious, that the fuel piping is preferably branching to all installed burners.

The ammonia cracker has further a cracker air channel extending from a cracker air inlet of the ammonia cracker to a cracker air outlet. In operation of the gas turbine arrangement a flow of a hot fluid through the air channel enables the transfer of heat from the hot fluid to the reaction channel.

To enable the cracking process, it is required to operate the ammonia cracker with the required temperature. To achieve a preferred efficiency and to reduce the installation effort, it is inventively foreseen that the ammonia cracker is arranged in-between the high-pressure expansion turbine and the low-pressure expansion turbine. Consequently, the cracker air input is arranged downstream of the outlet side of the high-pressure expansion turbine and the cracker air output of the ammonia cracker is arranged upstream of the inlet side of the low-pressure expansion turbine.

Here, the hot exhaust gas coming from the high-pressure expansion turbine is guided through the cracker air channel of the ammonia cracker and then further to the low-pressure expansion turbine, thereby transferring a share of the heat from the exhaust gas to the ammonia flowing through the cracker reaction channel.

In a first embodiment advantageously one ammonia cracker is used in-between the high-pressure expansion turbine and the low-pressure expansion turbine.

This solution is in particular advantage, if the ammonia cracker is only used for supplying the same gas turbine with the mixture of hydrogen and nitrogen without a relevant discharge of the fuel from the ammonia cracker external to the gas turbine arrangement.

In a further embodiment advantageously two or more ammonia crackers are installed in-between the high-pressure expansion turbine and the low-pressure expansion turbine. Each ammonia cracker comprises a cracker reaction channel and a cracker air channel, wherein in operation of the gas turbine arrangement ammonia is supplied to each of the ammonia inputs of the cracker reaction channels wherein a mixture of hydrogen and nitrogen is supplied from the cracker fuel outputs of each cracker reaction channel.

Here, the ammonia crackers should be arranged in sequence, so that the hot exhaust gas could flow in sequence through the cracker air channels of the given ammonia crackers.

This solution is in particular advantage, if hydrogen should be delivered to other facilities external to the gas turbine arrangement. Here, for example a number of further gas turbines could be supplied with hydrogen without the need for further ammonia crackers at the other gas turbines.

An ammonia cracker usually comprises a heater to heat the ammonia up to the required temperature to enable the cracking of the ammonia into hydrogen and nitrogen. If only one ammonia cracker is installed, the heat from the exhaust gas downstream of the high-pressure expansion turbine should be sufficient to enable the cracking process. Therefore, no additional heater should be required.

In case two or more ammonia crackers are installed, it may be required to increase the heat within the exhaust gas to enable the cracking process and to supply a sufficient energy transfer in the low-pressure expansion turbine. Therefore, it is advantage to implement a heater within at least one of the ammonia crackers, wherein this is preferably the last ammonia cracker(s) at the downstream side (relative to flow of the exhaust gas).

By using the heat of the compressed air with additional heating by the heater, the efficiency of the gas turbine arrangement could be increased and thereby the hot exhaust gas leaving the gas turbine could still be used for operation of a steam generator.

In principle it is possible to use an external energy source to operate the heater. Instead of using an external energy source for the heater of the ammonia cracker advantageously the cracked hydrogen is used as fuel for the heater.

The combustion of hydrogen, which has been cracked in the ammonia cracker, within the heater, a further increase of the efficiency of the gas turbine arrangement could be achieved.

It is obvious, that for a starting process initially the hydrogen for the additional heat in the ammonia cracker needs to be supplied externally. But in principle, in regular operation of the gas turbine arrangement, the hydrogen necessary to operate the heater advantageously should be diverted from the stream of hydrogen and nitrogen leaving the ammonia cracker at the fuel outlet.

Alternatively, it is possible to combust uncracked ammonia within the heater and/or the combustor at the start of the gas turbine arrangement. This will lead to a discharge of NOx the start process, but may be acceptable for a short period at the start of the gas turbine arrangement.

In principle it is possible to install a separate combustion system within the ammonia cracker to burn the hydrogen. But it is advantageous to burn the hydrogen directly within the air channel within the ammonia cracker. This reduces the installation effort and increases the efficiency.

It could be expected that the ammonia supplied from a source of ammonia has a low temperature compared to the required temperature within the ammonia cracker. The mixture of hydrogen and nitrogen leaving the ammonia cracker on the other hand has a high temperature due to the heating within the ammonia cracker required for the cracking process. Here, it is advantageous to reuse the heat in the mixture for the heating of the ammonia supplied to the ammonia cracker.

The gas turbine arrangement advantageously comprises a fuel heat exchanger arranged at the ammonia cracker. The fuel heat exchanger should have an exchanger ammonia passage and an exchanger fuel passage. The exchanger fuel passage needs to be connected at an exchanger fuel input with the cracker fuel output at the ammonia cracker. The exchanger ammonia passage needs to be connected at an exchanger ammonia output side with the cracker ammonia input of the ammonia cracker.

The source of ammonia needs to be connected with the exchanger ammonia input of the ammonia passage, wherein the exchanger fuel output of the fuel passage needs to be connected with the at least one combustor. Obviously, in this preferred embodiment the flow of fuel (first as ammonia and second as mixture of hydrogen and nitrogen) crosses the fuel heat exchanger twice.

To supply the preferred heater, especially in case of two or more ammonia crackers, with a share of the cracked ammonia, it is possible to connect the heater to the fuel piping between the cracker fuel output of the ammonia cracker and the exchanger fuel input of the ammonia passage. Alternatively, the heater could be connected to the fuel piping between the exchanger fuel output of the ammonia passage and the combustor.

It is possible to provide the ammonia by the source of ammonia in gaseous form.

If the source of ammonia provides the ammonia in liquid form, it is preferred to use additionally an ammonia vaporizer. The ammonia vaporizer should comprise a vaporizer fluid passage and a vaporizer ammonia passage, wherein the vaporizer ammonia passage is connected at a vaporizer ammonia input with the source of ammonia and at the vaporizer ammonia output with exchanger ammonia input of the exchanger ammonia passage of the preferred fuel heat exchanger.

The vaporizer fluid passage needs to be supplied with a heated medium.

In combination with the preferred ammonia vaporizer, it is advantageous to use the heat of the exhaust gas leaving the low-pressure expansion turbine for the pre-heating of the ammonia. Here two different solutions are proposed.

In a first embodiment the vaporizer fluid passage of the ammonia vaporizer is connected with the output side and with the input side with one of at least one of the heat exchangers installed within, for example, a steam generator.

In a second embodiment the ammonia vaporizer is arranged downstream the low-pressure expansion turbine, wherein the vaporizing passage is installed as heat exchanger and the passage for the exhaust gas is the vaporizer fluid passage of the ammonia vaporizer.

### BRIEF DESCRIPTION OF DRAWINGS

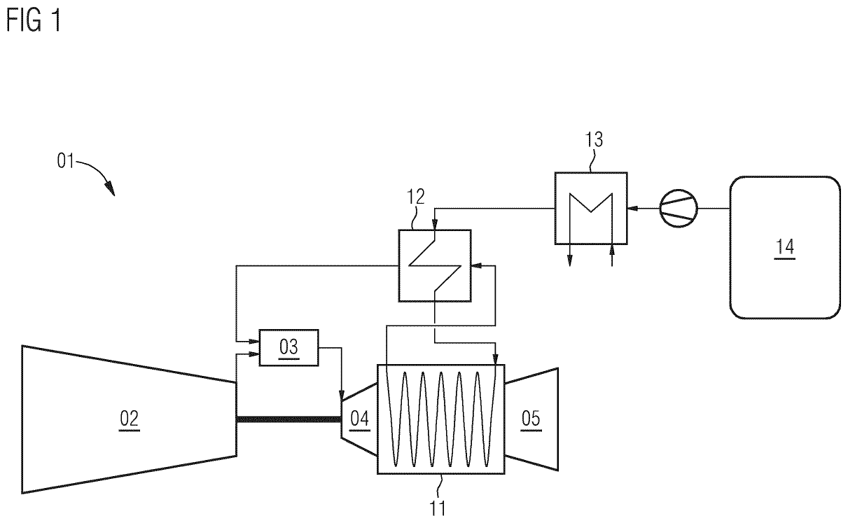

In FIG. 1, a first exemplary embodiment of an inventive gas turbine arrangement 01 with one ammonia cracker 11 arranged in-between the high-pressure expansion turbine and the low-pressure expansion turbine is schematically shown.

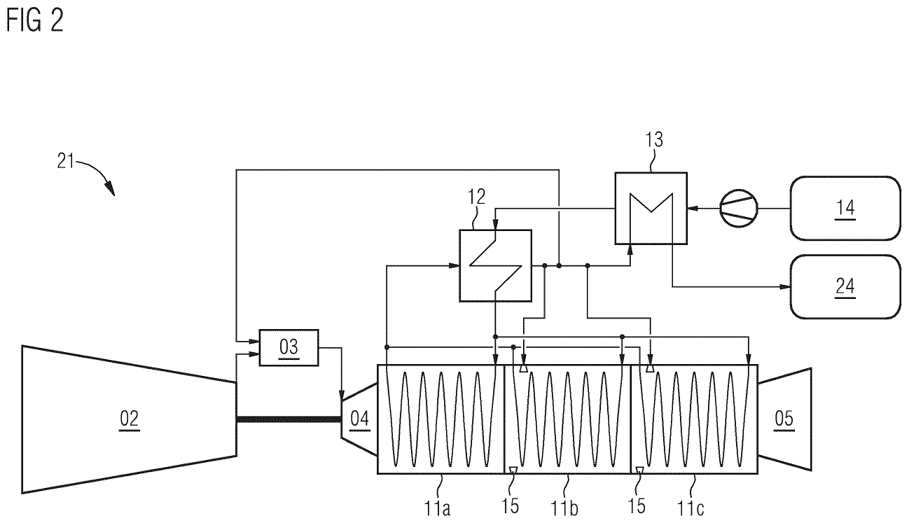

In FIG. 2, a second exemplary embodiment of an inventive gas turbine arrangement 21 with three ammonia crackers 11a, 11b, 11c is schematically shown.

### DETAILED DESCRIPTION OF THE DRAWINGS

The gas turbine arrangement 01 shown in FIG. 1 comprises a gas turbine with a compressor 02 and a combustor 03 and a high-pressure expansion turbine 04 and a low-pressure expansion turbine 05. The compressed combustion air is usually supplied from the compressor 02 to the combustor 03, wherein the produced exhaust gas is supplied from the combustor 03 to the high-pressure expansion turbine 04 to drive a gas turbine rotor. Then the hot exhaust gas is further supplied to the low-pressure expansion turbine 05 in regular use to drive a generator.

Further an ammonia cracker 11 is required, wherein the ammonia cracker 11 is arranged in-between the high-pressure expansion turbine 04 and the low-pressure expansion turbine 05. The ammonia cracker 11 has an cracker air channel connected with a cracker air inlet with the outlet side of the high-pressure expansion turbine 04. Consequently, the hot exhaust gas leaving high-pressure expansion turbine 04 flows into the cracker air channel of the ammonia cracker 11. At the low-pressure expansion turbine 05 is arranged with its input side at the cracker air outlet of the ammonia cracker 11, so that the exhaust gas after crossing the ammonia cracker 11 flows into the low-pressure expansion turbine 05.

Within the ammonia cracker 11 a cracker reaction passage is arranged. The reaction passage is supplied at a cracker ammonia input with gaseous ammonia. A mixture of hydrogen and nitrogen is delivered from a cracker fuel output of the cracker reaction channel. The heat in the cracker reaction channel to enable the cracking of ammonia is supplied by the hot exhaust gas.

The cracker ammonia input of the cracker reaction channel and also the cracker fuel output of the cracker reaction channel are connected to a fuel heat exchanger 12. The fuel heat exchanger 12 therefore comprises an exchanger ammonia passage and an exchanger fuel passage.

Ammonia is supplied to the exchanger ammonia passage at an input side. By crossing the fuel heat exchanger 12 the ammonia is heated up by use of the heat within the mixture of hydrogen and nitrogen passing through the exchanger fuel passage. This leads to an efficient reuse of the heat required in the ammonia cracker 11.

An exchanger fuel output of the exchanger fuel passage of the fuel heat exchanger 12 is connected with the combustor 03, so that the fuel-the mixture of hydrogen and nitrogen-could be used for the combustion process within the gas turbine.

To enable the usage of liquid ammonia as source 14 of ammonia, an ammonia vaporizer 13 is installed in-between the source 14 of ammonia and the fuel heat exchanger 12. The ammonia changes its state from liquid to gaseous within the ammonia vaporizer 13 by a heat transfer from a fluid into the ammonia.

FIG. 2 shows exemplary an extended gas turbine arrangement 21 comprising a gas turbine analogy previous embodiment with a compressor 02 and a combustor 03 and a high-pressure expansion turbine 04 and a low-pressure expansion turbine 05.

Instead of having just one ammonia cracker here, three ammonia crackers 11a, 11b, 11c are arranged in sequence in-between the high-pressure expansion turbine 04 and the low-pressure expansion turbine 05.

Each of the ammonia cracker 11a, 11b, 11c has a cracker air passage connected in sequence. Consequently, the hot exhaust gas leaving high-pressure expansion turbine 04 flows into the cracker air passage of the first ammonia cracker 11a and further through the cracker air passage of the second ammonia cracker 11b and further through the third ammonia cracker 11c. The low-pressure expansion turbine 05 is arranged with its input side at the cracker air outlet of the last ammonia cracker 11c, so that the exhaust gas after crossing the ammonia crackers 11 flows into the low-pressure expansion turbine 05.

Here, it is also intended to reuse the heat within the heated mixture of hydrogen and nitrogen leaving the ammonia crackers 11a, 11b, 11c by use of a fuel heat exchanger 12. The flow through the fuel heat exchanger is analogue the previous embodiment.

A share of the produced hydrogen is branched off and supplied to the heaters 15 within the ammonia crackers 11b, 11c to reach the required temperature for the cracking process.

Within the second and third ammonia cracker 11b, 11c heaters 15 are arranged. The heat in the cracker reaction passage to enable the cracking of ammonia is supplied in portion by the exhaust gas and in portion by the heaters 15.

With the use of more than one ammonia cracker 11a, 11b, 11c it is possible to crack more ammonia as that required for combustion within the combustor 03. This enables the delivery of hydrogen to external facilities. Here, as example a hydrogen storage 24 is shown.

As further improvement to increase the efficiency and to reuse the heat an ammonia vaporizer 13 is arranged within the flow of fuel. Liquid ammonia is supplied from a source 14 of ammonia to the vaporizer ammonia passage of the ammonia vaporizer 13 and a gaseous ammonia is supplied from the vaporizer ammonia passage to the exchanger ammonia passage of the fuel heat exchanger 12.

In this embodiment, the mixture of hydrogen and nitrogen flows in portion from the exchanger fuel passage of the fuel heat exchanger 12 through the vaporizer fluid passage of the ammonia vaporizer 13 and is then stored in a hydrogen storage 24.

It is obvious that it is also possible to guide the complete fuel from the fuel heat exchanger 12 to the ammonia vaporizer 13 before branching into a fuel piping to the combustor 03 and a connection to the heaters 15 and a connection to the storage 24.

1. A gas turbine arrangement comprising:
a gas turbine having a compressor and a combustor and a high-pressure expansion turbine and a low-pressure expansion turbine wherein in operation of the gas turbine, combustion air is compressed in the compressor and at least a part of the combustion air is supplied from an outlet of the compressor to the combustor and an exhaust gas is supplied in operation of the gas turbine from the combustor to the high-pressure expansion turbine and the exhaust gas is supplied further to the low-pressure expansion turbine
at least one ammonia cracker heaving a cracker air channel from a cracker air inlet to a cracker air outlet and a cracker reaction channel from a cracker ammonia inlet to a cracker fuel outlet;
wherein in use of the gas turbine arrangement the cracker ammonia inlet is intentionally connected to a source of ammonia;
wherein a fuel piping connects the cracker fuel outlet with the combustor
wherein the ammonia cracker is arranged in-between the high-pressure expansion turbine and the low-pressure expansion turbine and in operation of the gas turbine, the exhaust gas passes the cracker air channel.

2. The gas turbine arrangement according to claim 1,
wherein at least two ammonia crackers are arranged in sequence in-between the high-pressure expansion turbine and the low-pressure expansion turbine

3. The gas turbine arrangement according to claim 2,
wherein at least one of the ammonia crackers comprises a heater

4. The gas turbine arrangement according to claim 3,
wherein the heater is enabled to combust hydrogen within the cracker air channel.

5. The gas turbine arrangement according to claim 1, further comprising:
a fuel heat exchanger having an exchanger fuel passage and an exchanger ammonia passage, wherein the exchanger ammonia passage is connected at an exchanger ammonia input with the source of ammonia and at an exchanger ammonia output with the cracker ammonia inlet, wherein the exchanger fuel passage is connected at an exchanger fuel input with the cracker fuel outlet and at an exchanger fuel output with the combustor

6. The gas turbine arrangement according to claim 5, further comprising:
an ammonia vaporizer having a vaporizer fluid passage and a vaporizer ammonia passage, wherein the vaporizer ammonia passage is connected at an vaporizer ammonia input with the source of ammonia and at an vaporizer ammonia output with the exchanger ammonia input of the vaporizer ammonia passage.

7. A method to operate a gas turbine arrangement having a gas turbine arrangement according to claim 1, comprising:
supplying to and burning at least a share of compressed air and gaseous fuel in the combustor and supplying exhaust gas from the combustor to the high-pressure expansion turbine;
supplying the exhaust gas from the high-pressure expansion turbine to the at least one ammonia cracker;
supplying ammonia to the cracker ammonia inlet of the ammonia cracker and cracking the ammonia within the cracker reaction channel and supplying a mixture of hydrogen and nitrogen as gaseous fuel from the cracker fuel outlet to the combustor; and
supplying the exhaust gas from the ammonia cracker to the low-pressure expansion turbine.

8. The method according to claim 7,
wherein additional heat is introduced in the ammonia cracker by a heater.

9. The method according to claim 7,
wherein ammonia is supplied form a source of ammonia to a fuel heat exchanger and guided through an exchanger ammonia passage and from the fuel heat exchanger to the ammonia cracker;
wherein cracked gaseous fuel is guided from the cracker fuel outlet to the fuel heat exchanger and through an exchanger fuel passage and from the fuel heat exchanger to the combustor.

10. The method according to claim 7,
wherein a share of cracked gaseous fuel is extracted from the fuel piping and supplied to a heater and burned within the ammonia cracker.

11. The method according to claim 7,
wherein a share of cracked gaseous fuel is supplied externally of the gas turbine arrangement.
